(19) United States
(12) Patent Application Publication
(10) Pub. No.: US 2009/0213951 A1
(43) Pub. Date: Aug. 27, 2009

(54) Method of suppressing carrier leak in OFDM transmission and radio transmitter using same method

(75) Inventors: Minoru Okada, Yokohama-city (JP); Kenichi Koeda, Yokohama-city (JP); Toshiyuki Morishita, Nagoya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/320,156

(22) Filed: Jan. 21, 2009

(30) Foreign Application Priority Data
Feb. 22, 2008 (JP) 2008-41354

(51) Int. Cl. H04L 27/28

(52) U.S. Cl. 375/260

(57) ABSTRACT

In an OFDM type radio transmitter, an orthogonal modulator performs an orthogonal modulation of an I-component and a Q-component, an orthogonal component output circuit produces the I-component and the Q-component in accordance with set values, and a correction circuit sets the I-component and the Q-component to zero. The correction circuit further corrects offset values of the I-component and the Q-component by way of the orthogonal component output circuit to minimize an output power of the orthogonal modulator. The number of times of changing the set values of the orthogonal component output circuit is limited to predetermined values in correcting the offset values.

### CROSS REFERENCE TO RELATED APPLICATION

This application is based on and incorporates herein by reference Japanese Patent Application No. 2008-41354 filed on Feb. 22, 2008.

### FIELD OF THE INVENTION

The present invention relates to a method of suppressing carrier leak in OFDM type radio transmission and a radio transmitter using the same method.

### BACKGROUND OF THE INVENTION

In conventional mobile digital sound broadcasting and ground digital radio communication, an orthogonal frequency division multiplexing (OFDM) method is used. The OFDM method is one of multi-carrier modulating methods, in which information are divided and transmitted by a plurality of low rate carrier waves (carriers).

According to the OFDM method, the interval between adjacent carriers can be made close to each other because of orthogonal transmission. As a result, the frequency efficiency can be enhanced. Further, the bit rate of signals transmitted by respective carriers can be reduced, and influence of noise at the time of signal transmission can be reduced.

However, according to the OFDM method, the phases of sub-carrier modulation signals become the same. As a result, the peak power becomes large and the modulation signal tends to have instable amplitude. As the amplitude of the modulation signal varies, it becomes necessary to increase the power ratio (carrier leak ratio) between the transmitted signal and the carrier leak, which is a leak of the carrier signal to the output side. For this reason, the carrier leak must be suppressed.

The carrier leak arises from offset of a transmitter circuit. The offset arises from variations in the operation characteristics and the resistances of transistors in an integrated circuit, and exists in any transistors. Since field effect transistors (FETs) on the same chip vary more when manufactured as complementary MOS transistors, it becomes more essential to suppress the carrier leak.

To suppress the carrier leak, JP 2001-223535 proposes to manually adjust bias voltages of transistors that cause the carrier leak.

This manual adjustment of the bias voltage is not effective against time changes (aging) of devices after shipment or temperature changes around the devices. Further it requires increased man-hour for the adjustment work.

### SUMMARY OF THE INVENTION

It is therefore an object of the present invention to provide a method and a device that can surely suppress carrier leak in a simple way.

According to the present invention, an OFDM type radio transmitter performs an orthogonal modulation of an I-component and a Q-component, which are orthogonal to each other. To suppress carrier leak, the radio transmitter sets the I-component and the Q-component to zero and detects an output power of the orthogonal modulator when zero is set. At least one of offset values of the I-component and the Q-component is corrected to minimize the detected output power.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing an OFDM type radio transmitter according to an embodiment of the present invention;

FIG. 2 is a flowchart showing correction processing executed in the embodiment; and

FIG. 3 is a chart showing carrier leak suppression of an orthogonal modulator in the embodiment.

### DETAILED DESCRIPTION OF THE EMBODIMENT

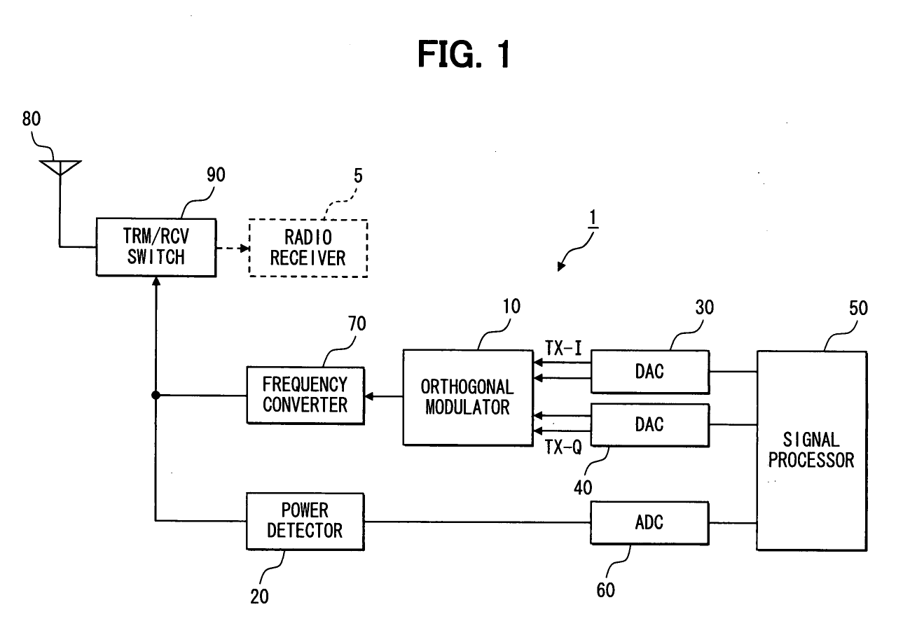

The present invention will be described in detail below with reference to an embodiment shown in FIG. 1, in which a radio transmitter 1 is designated with numeral 1.

The radio transmitter 1 is an OFDM type and has an orthogonal modulator 10, a power detector 20, a digital-analog converters (DAC) 30, 40, a signal processor 50, an analog-digital converter (ADC) 60, a frequency converter 70, an antenna 80 and a transmitting/receiving (TRM/RCV) change-over switch 90.

The orthogonal modulator 10 is configured to orthogonally modulate the in-phase component (I-component) and the quadrature component (Q-component), which are orthogonal to each other. The I-component indicated as TX-I is produced by the DAC 30, and the Q-component indicated as TX-Q is produced by the DAC 40.

The power detector 20 is an electric power meter configured to detect an output power of the orthogonal modulator 10. The power detector 20 may also be used to control the transmission power. The DAC 30 is configured to convert the I-component produced as a digital signal by the signal processor 50 into an analog signal, and also change an offset voltage of an input signal of the orthogonal modulator 10 by changing its offset value.

The DAC 40 is configured to convert the Q-component produced as a digital signal by the signal processor 50 into an analog signal, and also change an offset voltage of an input signal of the orthogonal modulator 10 by changing its offset value. The DAC 30 and the DAC 40 are thus configured to form an orthogonal component output circuit and independently change the offset values of the I-component and the Q-component, which are orthogonal.

The digital signal of the signal processor 50 is produced to the DAC 30 as dual line complementary signals (positive side and negative side). Therefore, the offset value can be changed independently between the positive side and the negative side. This is also true for the digital signal produced from the signal processor 50 to the DAC 40.

The signal processor 50 is configured to set the I-component and the Q-component to zero and cause the DAC 30, 40 to correct the offset voltage of the input signals of the orthogonal modulator 10. In this control, the power detector 20 detects the output power of the orthogonal modulator 10, and the DAC 30 and the DAC 40 change at least one of the offset values of the I-component and the Q-component thereby to minimize the detected power.

The signal processor 50 is configured to change the offset values of the I-component and the Q-component, which are set in the DAC 30 and the DAC 40, when the offset voltages of the signals input to the orthogonal modulator 10 are changed by the DAC 30 and the DAC 40. Thus, the offset voltages of the signals input to the orthogonal modulator 10 are corrected.

The signal processor 50 limits the number of times of changing the offset values by the DAC 30 and the DAC 40 to predetermined limit values when the offset voltages of the input signals applied to the orthogonal modulator 10 are changed. Each predetermined limit value may be set to correspond to a ratio determined by dividing a maximum error in the offset voltage by an allowable error of the offset voltage.

The ADC 60 is a conventional circuit configured to convert the electric power detected by the power detector 20 to a digital signal, which is applied to the signal processor 50. The frequency converter 70 includes an oscillator, which generates a reference signal of a high frequency, and is configured to convert the output signal of the orthogonal modulator 10 to a radio signal of a predetermined frequency by using the high frequency signal generated by the oscillator. The frequency converter 70 may be a super heterodyne type.

The antenna 80 is for transmitting the radio signal produced by the frequency converter 70 outward. The type of antenna 80 may be determined in accordance with various parameters, which include the frequency of radio signal, the polarized wave of the radio signal, transmission/reception power, or location or setting condition.

For example, the antenna 80 may be a basic antenna such as a dipole antenna, a loop antenna or a combined antenna. Alternatively, the antenna may be an open antenna such as a horn antenna or a parabola antenna, or may be an array antenna in which a plurality of radiation elements is arranged.

The change-over switch 90 is provided to switch the electric connection of the antenna 80 to either the radio transmitter 1 and a radio receiver 5, so that the radio signal of the radio transmitter 1 is transmitted to the antenna 80 and a radio signal received by the antenna 80 is inputted to the radio receiver 5. The change-over switch 90 may be formed by a high frequency switch such as a PIN diode.

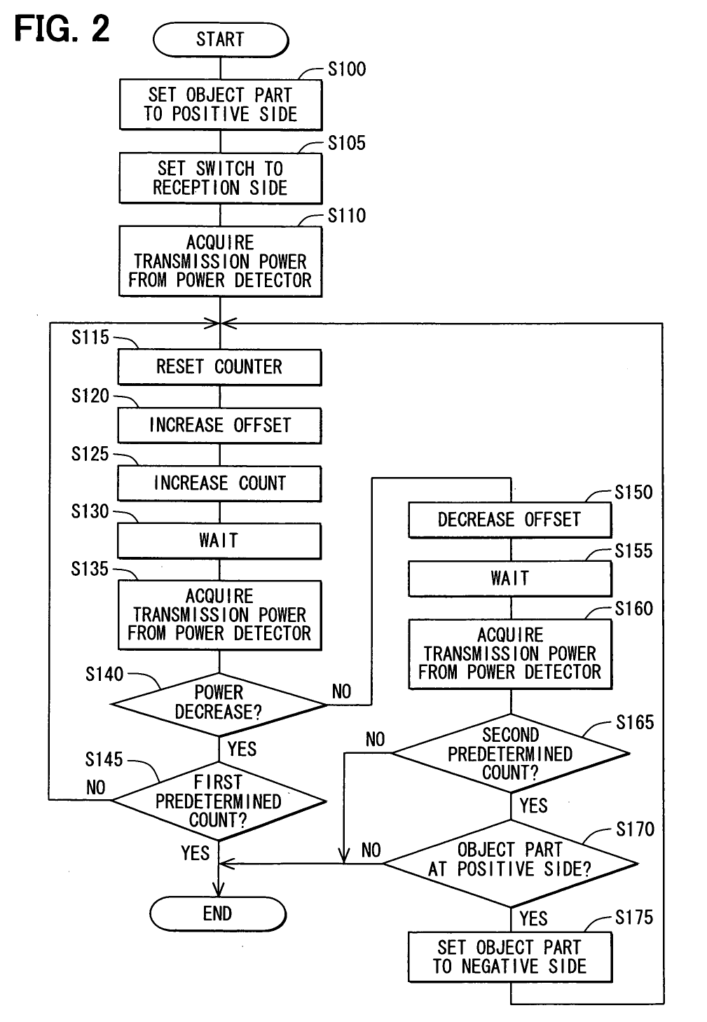

The signal processor 50 may be a microcomputer configured or programmed as a correction circuit to execute offset correction processing shown in FIG. 2. The following correction processing is executed with respect to each of the I-component and the Q-component, which are orthogonal to each other. However, the following description is made with respect to only one of the components, that is, only the Q-component. Therefore it is to be understood that the similar correction processing is executed for the I-component after finishing the Q-component correction processing of FIG. 2.

First at S100, the object part of a signal to be corrected (adjusted) is set to the positive side. That is, the positive logic signal of the complementary signal is set as the object part for adjustment. At S105, the change-over switch 90 is switched to the signal reception side, so that the radio signal received by the antenna 80 is not detected by the power detector 20. Thus, only the transmission power (output power) of the carrier leak is detected by the power detector 20, and the carrier leak will not be radiated from the antenna 80.

At S110, the transmission power detected by the power detector 20 is acquired. Then at S115, a counter (not shown) provided in the signal processor 50 to count the number of times of changing the offset value is reset thereby resetting the count to zero. At S120, the offset voltage in the DAC 40, that is, the offset value of the Q-component, is increased by a predetermined amount (4 mV). At S125, the count of the counter is increased to increment the number of times of offset changing. At S130, the processing holds for a predetermined wait time, which is a response time (e.g., 16 μs) of the power detector 20.

At S135, the transmission power is acquired again from the power detector 20. At S140, it is checked whether the power acquired at S135 (after the increase of offset) has decreased from the power acquired at S110 (before the increase of offset).

If the transmission power has decreased (S140: YES), the processing proceeds to S145. If the transmission power has not decreased (S140: NO), the processing proceeds to S150.

At S145, it is checked whether the count of the counter has reached a first predetermined count, which corresponds to the maximum limit of the increase of the offset value. This predetermined count may be set to an integer number (e.g., 5) that is greater than a ratio determined by dividing the maximum error of the offset voltage by the allowable error of the offset voltage. If the count is not the first predetermined count (S145: NO), the processing returns to S115 to further increase the offset value. If the count is the first predetermined count (S145: YES), the processing ends.

At S150, the offset voltage in the DAC 40 is decreased by a predetermined amount (e.g., 4 mV). At S155, the processing holds for a predetermined wait time (e.g., 16 μs). At S160, the transmission power is acquired again from the power detector 20. At S165, it is checked whether the count of the counter is a second predetermined count (1). This step is for checking whether the optimum value of the offset adjustment is at the positive side or the negative side. If the count is the second predetermined count (S165: YES), the processing proceeds to S170. If the count is not the second predetermined count (S165: NO), the processing ends.

At S170, it is checked whether the object part of adjustment is the positive side. If it is the positive side (S170: YES), the processing proceeds to S175. If it is not (S170: NO), the processing ends.

At S175, the object part of the adjustment is set to the negative side from the positive side. Thus, if the count of the counter is the second predetermined count (1) and the object part of adjustment is the positive side, it means that the carrier leak cannot be suppressed any more even if the offset voltage of the positive side is increased (the offset value of the complementary signal is increased). In this instance, the object part of adjustment is changed to the signal of negative logic side of the complementary signal, the processing returns to S115 so that the offset adjustment is made on the negative logic side in the same manner. That is, the correction processing for suppressing the carrier leak is performed by increasing the offset voltage of the negative side (by decreasing the offset value of the complementary signal).

According to the OFDM type radio transmitter 1, the I-component and the Q-component are set to zero, and the output power of the orthogonal modulator 10 is detected by the power detector 20 by way of the frequency converter 70. As a result, the electric power of only the carrier signal leaking to the output side can be detected.

The signal processor 50 operates to correct the offset values of the I-component and the Q-component by adjusting the set values of the I-component and the Q-component so that the electric power detected by the power detector 20 becomes a minimum. As a result, the carrier signal that leaks, that is, carrier leak, can be minimized.

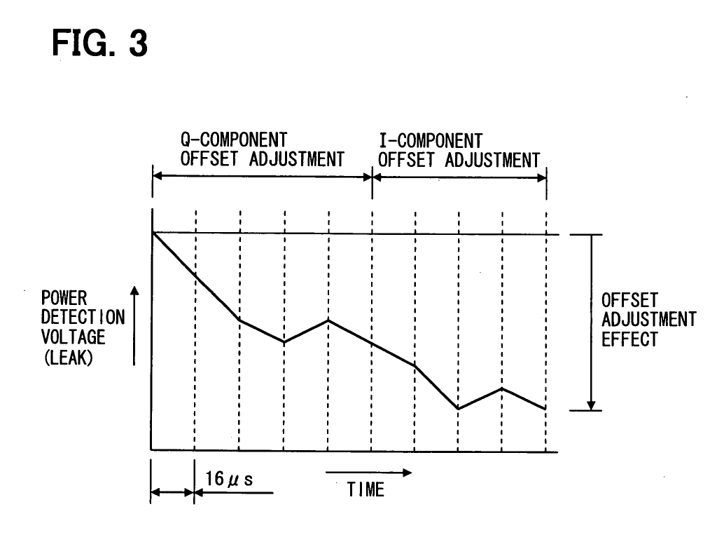

This operation of suppressing carrier leak is graphically shown in FIG. 3. As shown in this figure, the offset value of the Q-component is first changed at every predetermined interval (16 μs) to decrease the transmission power of the orthogonal modulator 10. While it is decreasing, the power detection voltage of the power detector 20 decreases correspondingly.

If the power detection voltage increases, the offset value of the Q-component is returned to the previous offset value and the offset correction for the Q-component is finished. Then the other offset correction for the I-component is performed in the same manner as the offset correction for the Q-component.

Since the I-component and the Q-component must necessarily be set in the OFDM method and these signals are changed, additional devices or circuits need not be provided to adjust the offset values. As a result, the offset values can be adjusted in a simplified method and configuration.

Since the number of times of changing the offset values of the I-component and the Q-component is limited to the predetermined number, the carrier leak can be suppressed in a short time.

The embodiment described above may be modified in various ways. For instance, the predetermined number of times for limiting the number of changing the offset value may be set to a different value determined experimentally in place of dividing the maximum error by the allowable error of the offset voltage.

What is claimed is:

1. A method for suppressing carrier leak for an OFDM type radio transmitter that includes an orthogonal modulator for performing an orthogonal modulation of an I-component and a Q-component, which are orthogonal to each other, and a power detector for detecting an output power of the orthogonal modulator, the method comprising:
setting the I-component and the Q-component to zero;
detecting the output power of the orthogonal modulator at the time of setting of zero; and
correcting at least one of offset values of the I-component and the Q-component to minimize the output power detected by the power detector thereby to suppress carrier leak.

2. The method according to claim 1, further comprising:
changing a set value of an orthogonal component output circuit thereby to correct the offset values, the orthogonal component output circuit producing the I-component and the Q-component.

3. The method according to claim 2, further comprising:
limiting the number of times of changing the set value of the orthogonal component output circuit to a predetermined value in correcting the offset value.

4. The method according to claim 2, wherein the I-component and the Q-component are produced by digital-analog converters of the orthogonal component output circuit, respectively.

5. An OFDM type radio transmitter comprising:
an orthogonal modulator configured to perform an orthogonal modulation of an I-component and a Q-component, which are orthogonal to each other;
a power detector configured to detect an output power of the orthogonal modulator;
an orthogonal component output circuit configured to produce the I-component and the Q-component in accordance with set values; and
a correction circuit configured to set the I-component and the Q-component to zero, and correct offset values of the I-component and the Q-component by way of the orthogonal component output circuit to minimize the output power detected by the power detector.

6. The radio transmitter according to claim 5, wherein:
the orthogonal component output circuit is configured to change the offset values of the I-component and the Q-component independently; and
the correction circuit is configured to change at least one of the set values of the I-component and the Q-component by way of the orthogonal component output circuit thereby to correct the offset values.

7. The radio transmitter according to claim 5, wherein the correction circuit is configured to limit the number of times of changing the set values of the orthogonal component output circuit to predetermined values in correcting the offset values.

8. The radio transmitter according to claim 5, wherein the orthogonal component output circuit includes digital-analog converters for the I-component and the Q-component, respectively.
